(19) United States
(12) Patent Application Publication
(10) Pub. No.: US 2005/0261093 A1
(43) Pub. Date: Nov. 24, 2005

(54) Power transmission device

(75) Inventors: Takashi Shimizu, Kariya-city (JP); Michiyasu Nosaka, Anjo-city (JP); Kiyoshi Kurohata, Kariya-city (JP); Naoto Agata, Toyoake-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/132,248

(22) Filed: May 19, 2005

(30) Foreign Application Priority Data
May 21, 2004 (JP) 2004-152395

(51) Int. Cl. F16H 55/36; F16H 63/00

(52) U.S. Cl. 474/70; 474/199

(57) ABSTRACT

A power transmission device includes a driving-side rotating body and a driven-side rotating body. The driving-side rotating body rotates via a drive source and has a concave fitting portion. The driven-side rotating body is connected to a rotary shaft and has a convex fitting portion. The convex fitting portion engages the concave fitting portion to transmit rotation of the driving-side rotating body to the driven-side rotating body. The driven-side rotating body includes an annular outer hub formed of resin and an annular inner hub formed of metal. The outer hub is in an outer circumferential part of the driven-side rotating body and has the convex fitting portion. The inner hub is in an inner circumferential part of the driven-side rotating body. The inner hub is insert molded into the outer hub. An outer diameter of the inner hub is larger than an inner diameter of the convex fitting portion.

### CROSS REFERENCE TO RELATED APPLICATIONS

This application is based upon and claims the benefit of priority of Japanese Patent Application No. 2004-152395, filed on May 21, 2004, the contents of which are incorporated herein by reference.

### FIELD OF THE INVENTION

The present invention relates to a power transmission device for transmitting a rotary power from a drive source to a rotary shaft of a turning device and, more particularly, to a power transmission device that can be suitably applied to a compressor pulley in the case where a drive source drives a turning device of a vehicular air conditioner.

### BACKGROUND OF THE INVENTION

A conventional refrigeration cycle including a variable-capacitance refrigerant compressor that can change the discharge amount of refrigerant to 0% of its capacity, for example, does not require a clutch mechanism for interrupting transmission of a rotary power (torque) from an engine to a drive shaft of the refrigerant compressor. However, in the case where the clutch mechanism is not used, an overload torque (a torque causing a limiter to operate) that is extremely larger than a normally transmitted torque is generated when the drive shaft of the refrigerant compressor is locked because of breakdown of the refrigerant compressor caused by burning thereof, for example.

The lock of the refrigerant compressor stops revolution of a pulley for driving the driving shaft of the refrigerant compressor and causes slip and wear of a belt driven by the engine. Thus, heat generation or the like may be caused so as to break the belt. In order to avoid this problem, the applicant of the present application has proposed a power transmission device provided with a torque limiter mechanism, as described in Japanese Patent Laid-Open Publication No. 2002-54711. This torque limiter mechanism blocks a power transmission path from the engine to the drive shaft of the refrigerant compressor, when an overload torque is generated because of lock of the drive shaft of the refrigerant compressor or the like and therefore a torque difference equal to or larger than a set torque is generated between the pulley and the drive shaft of the refrigerant compressor.

This power transmission device includes a pulley driven by the engine through a belt, and an output disk connected to the pulley with a rubber elastic member (hereinafter, referred to as a rubber dumper) and a pin portion interposed therebetween. The output disk is connected to the drive shaft of the refrigerant compressor. The rubber damper serves as a damping mechanism for absorbing a torque variation caused by compression work of the refrigerant compressor and reducing transmission of vibration (variation of an angle of rotation) to a vehicle through the belt so as to reduce an in-vehicle noise.

The output disk includes an outer hub that is formed of a resin and is arranged in its outer circumferential part and an inner hub that is formed of a metal and is arranged in its inner circumferential part. The inner hub is formed by insert molding onto the inner circumferential side of the outer hub. The inner hub has an inner ring portion connected to the drive shaft of the refrigerant compressor, an outer ring portion arranged in the outer circumferential part of the inner hub, and a bridge connecting the inner ring portion to the outer ring portion. The inner hub serves as a torque limiter mechanism that is broken at the bridge to block power transmission when an overload torque (a torque causing a limiter to operate) is generated.

However, the variable-capacitance refrigerant compressor employing the conventional power transmission device described above has the following problem. When the compression work of the refrigerant compressor is zero (i.e., the refrigerant compressor is turned off), play inside the refrigerant compressor and play in the power transmission device (displacement of the pulley and the output disk with respect to each other caused by compression of the rubber damper, see FIGS. 9A and 9B) may cause vibration of the output disk. This causes generation of abnormal noises around a frequency band of 1.5 to 2 kHz in the output disk.

FIG. 9A shows a state where a positive torque is applied between a rubber damper 9 and a pin portion 23, and FIG. 9B shows a state where a negative torque is applied. Moreover, FIG. 5 is a graph showing a relationship between the frequency of sound generated by the refrigerant compressor and a sound pressure. In FIG. 5, a peak shown as a conventional product represents the controversial noise. The present invention aims to overcome the aforementioned problem. It is an object of the present invention to provide a power transmission device which can suppress vibration of an output disk as a source of sound and can reduce noises.

### SUMMARY OF THE INVENTION

According to one aspect of the present invention, a power transmission device includes a driving-side rotating body rotated by a rotary power from a drive source, the driving-side rotating body having a concave fitting portion provided on an end face thereof in an axial direction; and a driven-side rotating body connected to a rotary shaft of a turning device, the driven-side rotating body having a convex fitting portion provided on an end face in the axial direction, the convex fitting portion being fitted into the concave fitting portion to be connected thereto to transmit rotation of the driving-side rotating body to the driven-side rotating body. In this power transmission device, the driven-side rotating body includes an annular outer hub formed of a resin and an annular inner hub formed of a metal. The outer hub is arranged in an outer circumferential part of the driven-side rotating body and has the convex fitting portion. The inner hub is arranged in an inner circumferential part of the driven-side rotating body, is formed into the outer hub by insert molding, and is connected to an outer circumference of the rotary shaft. An outer diameter of the inner hub is set to be larger than an inner diameter of the convex fitting portions.

The present invention provides a structure that increases the rigidity of the driven-side rotating body as a source of sound so as to suppress vibration of the driven-side rotating body (i.e., generation of sound in the driven-side rotating body). According to the first aspect of the invention, the rigidity of the driven-side rotating body is increased by making the outer diameter of the inner hub made of a metal larger until it reaches the size of the convex fitting portions made of a resin.

According to this aspect of the present invention, the vibration of the driven-side rotating body can be suppressed, and noises around the frequency band of 1.5 to 2 kHz that are generated in a conventional technique while a refrigerant compressor as the turning device is turned off can be reduced. Moreover, the structure can reduce the noises only by modifying the driven-side rotating body without increasing the size of the driven-side rotating body or modifying other components of the power transmission device. In addition, a torque (rotation) variation caused by compression work of the refrigerant compressor can be also reduced due to increase of inertia weight of the inner hub.

According to another aspect of the present invention, a power transmission device includes a driving-side rotating body rotated by a rotary power from a drive source, the driving-side rotating body having a concave fitting portion provided on an end face thereof in an axial direction; and a driven-side rotating body connected to a rotary shaft of a turning device, the driven-side rotating body having a convex fitting portion provided on an end face thereof in the axial direction, the convex fitting portion being fitted into the concave fitting portion to be connected thereto to transmit rotation of the driving-side rotating body to the driven-side rotating body. In this power transmission device, the driven-side rotating body includes an annular outer hub made of a resin and an annular inner hub made of a metal. The outer hub is arranged in an outer circumferential part of the driven-side rotating body and has the convex fitting portion. The inner hub is arranged in an inner circumferential part of the driven-side rotating body and is formed into the outer hub by insert molding. The inner hub includes an approximately cylindrical inner ring portion connected to an outer circumference of the rotary shaft, and an outer ring portion in the form of an approximately annular plate that is arranged on an outer circumferential side of the inner ring portion. The outer ring portion has a thickness of 3 mm or more, preferably 4 mm or more.

This aspect of the present invention also provides a structure that increases the rigidity of the driven-side rotating body serving as the source of sound so as to suppress the vibration of the driven-side rotating body (i.e., generation of sound in the driven-side rotating body). More specifically, in this aspect, the rigidity of the driven-side rotating body is increased by making the thickness of the outer ring portion of the inner hub made of a metal thicker.

According to this aspect of the present invention, the vibration of the driven-side rotating body can be suppressed, and the noises around the frequency band of 1.5 to 2 kHz that are generated in the conventional technique while a refrigerant compressor as the turning device is turned off can be reduced. Moreover, the structure of the second aspect can reduce the noises only by modifying the driven-side rotating body without increasing the size of the driven-side rotating body or modifying other components of the power transmission device. In addition, the torque (rotation) variation caused by the compression work of the refrigerant compressor can be reduced due to the increase of inertia weight of the inner hub.

According to another aspect of the present invention, the driven-side rotating body further includes a disk cover for covering an end face of the inner hub in the axial direction. The disk cover is formed of a nonmetallic material.

This aspect of the present invention provides a structure that changes the natural frequency of the disk cover serving as one source of sound so as to suppress generation of sound in the disk cover. According to this aspect of the invention, the disk cover is formed of a nonmetallic material such as gasket, varnished sheet, paper, cloth, or rubber, whereas the disk cover is conventionally formed by an aluminum plate.

The use of the material having a different natural frequency from that of aluminum can change a resonance point. Thus, the noises around the frequency band of 1.5 to 2 kHz that are generated in the conventional technique while the refrigerant compressor as the turning device is turned off can be reduced. Moreover, the structure of the third aspect can reduce the noises only by modifying the disk cover without modifying the other components of the power transmission device.

According to yet another aspect of the present invention, a power transmission device includes a driving-side rotating body rotated by a rotary power from a drive source, the driving-side rotating body having a concave fitting portion on an end face thereof in an axial direction; and a driven-side rotating body connected to a rotary shaft of a turning device, the driven-side rotating body having a convex fitting portion provided on an end face thereof in the axial direction, the convex fitting portion being fitted into the concave fitting portion to be connected thereto to transmit rotation of the driving-side rotating body to the driven-side rotating body. In this power transmission device, the driven-side rotating body includes an annular outer hub made of a metal and an annular inner hub made of a metal. The outer hub is arranged in an outer circumferential part of the driven-side rotating body and has the convex fitting portion. The inner hub is arranged in an inner circumferential part of the driven-side rotating body and is connected to the outer hub and an outer circumference of the rotary shaft.

This aspect of the invention also provides a structure that increases the rigidity of the driven-side rotating body serving as the source of sound so as to suppress the vibration of the driven-side rotating body (i.e., generation of sound in the driven-side rotating body). More specifically, this aspect of the invention increases the rigidity of the driven-side rotating body by forming the outer hub, which is conventionally formed of a resin, of a metal.

According to this aspect of the invention, the vibration of the driven-side rotating body can be suppressed, and the noises around the frequency band of 1.5 to 2 kHz that are conventionally generated while a refrigerant compressor as the turning device is turned off can be reduced. Moreover, the structure can reduce the noises only by modifying the driven-side rotating body without increasing the size of the driven-side rotating body or modifying other components of the power transmission device. In addition, the torque (rotation) variation caused by the compression work of the refrigerant compressor can be reduced due to the increase of inertia weight of the driven-side rotating body.

According to yet another aspect of the present invention, the outer hub covers an end face of the inner hub in the axial direction. Thus, the need of the disk cover can be eliminated, so that the cost of the power transmission device can be suppressed.

According to yet another aspect of the present invention, a power transmission device includes a driving-side rotating body rotated by a rotary power from a drive source, the driving-side rotating body having a concave fitting portion provided on an end face thereof in an axial direction; and a driven-side rotating body connected to a rotary shaft of a turning device, the driven-side rotating body having a convex fitting portion provided on an end face thereof in the axial direction, the convex fitting portion being fitted into the concave fitting portion to be connected thereto to transmit rotation of the driving-side rotating body to the driven-side rotating body. In this power transmission device, the driven-side rotating body includes an approximately cylindrical inner ring portion connected to an outer circumference of the rotary shaft, and an outer ring portion in the form of an approximately annular plate that is arranged on an outer circumferential side of the inner ring portion and has the convex fitting portion. The inner ring portion and the outer ring portion are integrally formed of a metal.

This aspect of the invention also provides a structure that increases the rigidity of the driven-side rotating body serving as the source of sound so as to suppress the vibration of the driven-side rotating body (i.e., generation of sound in the driven-side rotating body). More specifically, in the sixth aspect of the invention, the driven-side rotating body, which is conventionally formed by the outer hub and the inner hub is formed of a metal as one piece so as to increase the rigidity of the driven-side rotating body.

According to this aspect of the invention, the vibration of the driven-side rotation body can be suppressed, and the noises around the frequency band of 1.5 to 2 kHz that are conventionally generated while a refrigerant compressor as the turning device is turned off can be reduced. Moreover, the structure can reduce the noises only by modifying the driven-side rotating body without increasing the size of the driven-side rotating body or modifying other components of the power transmission device. In addition, the torque (rotation) variation caused by the compression work of the refrigerant compressor can be reduced due to the increase of inertia weight of the driven-side rotating body.

According to yet another aspect of the present invention, a power transmission device includes a driving-side rotating body rotated by a rotary power from a drive source, the driving-side rotating body having a concave fitting portion provided on an end face thereof in an axial direction; and a driven-side rotating body connected to a rotary shaft of a turning device, the driven-side rotating body having a convex fitting portion provided on an end face thereof in the axial direction, the convex fitting portion being fitted into the concave fitting portion to be connected thereto to transmit rotation of the driving-side rotating body to the driven-side rotating body. In this power transmission device, the driven-side rotating body includes an annular outer hub made of a resin, an annular inner hub made of a metal, and a sound absorbing member for covering end faces of the outer hub and the inner hub in the axial direction. The outer hub is arranged in an outer circumferential part of the driven-side rotating body and has the convex fitting portion. The inner hub is arranged in an inner circumferential part of the driven-side rotating body, is formed into the outer hub by insert molding, and is connected to an outer circumference of the rotary shaft.

The seventh aspect of the invention provides a structure that suppresses propagation of sound from the driven-side rotating body serving as the source of sound by covering the driven-side rotating body with the sound absorbing member. The sound absorbing member covers one end face of the driven-side rotating body. According to this aspect of the invention, the propagation of sound from the driven-side rotating body can be suppressed, and the noises around the frequency band of 1.5 to 2 kHz that are conventionally generated while a refrigerant compressor as the turning device is turned off can be reduced.

Moreover, the structure can reduce the noises only by adding the sound absorbing member without increasing the size of the driven-side rotating body or modifying other components of the power transmission device. In addition, the sound absorbing member has a function of protecting a torque limiter mechanism and a function of preventing broken pieces from being scattered after the torque limiter mechanism operates, which are functions of the disk cover. Thus, the need of the disk cover can be eliminated and the cost of the power transmission device can be suppressed. A reference numeral in parenthesis after the aforementioned means represents exemplary correspondence between the aforementioned means and specific means described in embodiments that are described below.

Other features and advantages of the present invention will be appreciated, as well as methods of operation and the function of the related parts from a study of the following detailed description, appended claims, and drawings, all of which form a part of this application. In the drawings:

### BRIEF DESCRIPTION OF THE DRAWINGS

FIG. 1A is a front view of a compressor pulley assembly according to a first embodiment of the present invention;

FIG. 1B is a partial side and cross-sectional view of the compressor pulley assembly of FIG. 1A;

FIG. 2A is a partial front view of an inside surface of an output disk of the compressor pulley assembly of FIGS. 1A and 1B;

FIG. 2B is a partial cross-sectional view of the output disk of FIG. 2A;

FIG. 2C is a partial cross-sectional view of a conventional output disk;

FIG. 3A is a front view of an inner hub of the compressor pulley assembly of FIGS. 1A and 1B;

FIG. 3B is a cross-sectional view of the inner hub of FIG. 3A;

FIG. 4A is a front view of a disk cover of the compressor pulley assembly of FIGS. 1A and 1B;

FIG. 4B is a cross-sectional view of the disk cover of FIG. 4A;

FIG. 5 is a graph of a relationship between a frequency of sound generated by a compressor and a sound pressure illustrating an effect of the present invention;

FIG. 6 is a partial cross-sectional view of an output disk according to a second embodiment of the present invention;

FIG. 7 is a partial cross-sectional view of an output disk according to a third embodiment of the present invention;

FIG. 8 is a partial cross-sectional view of an output disk according to a fourth embodiment of the present invention;

FIG. 9A is a partial front view of a related compressor pulley assembly in a state in which a positive torque is applied between a rubber damper and a pin portion; and

FIG. 9B is a partial front view of the related compressor pulley assembly of FIG. 9A in a state in which a negative torque is applied between the rubber damper and the pin portion.

### DETAILED DESCRIPTION OF THE PREFERRED EMBODIMENTS

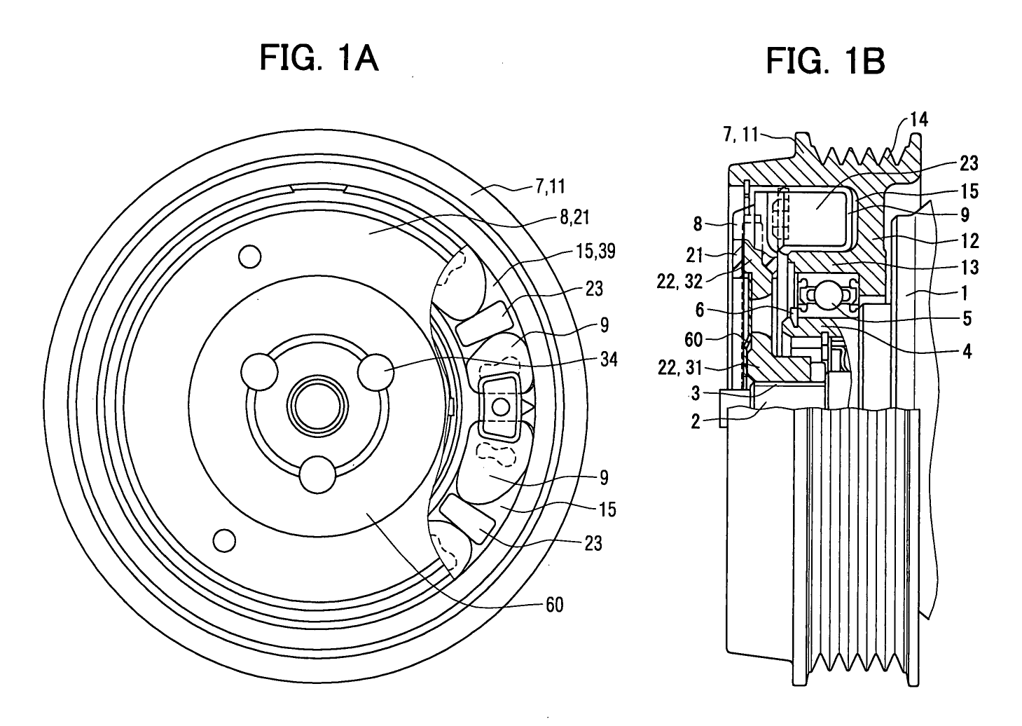

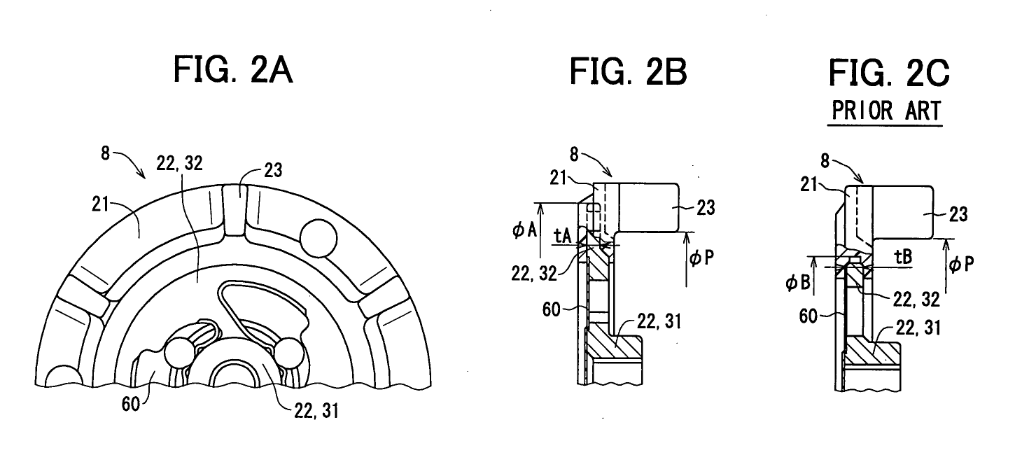

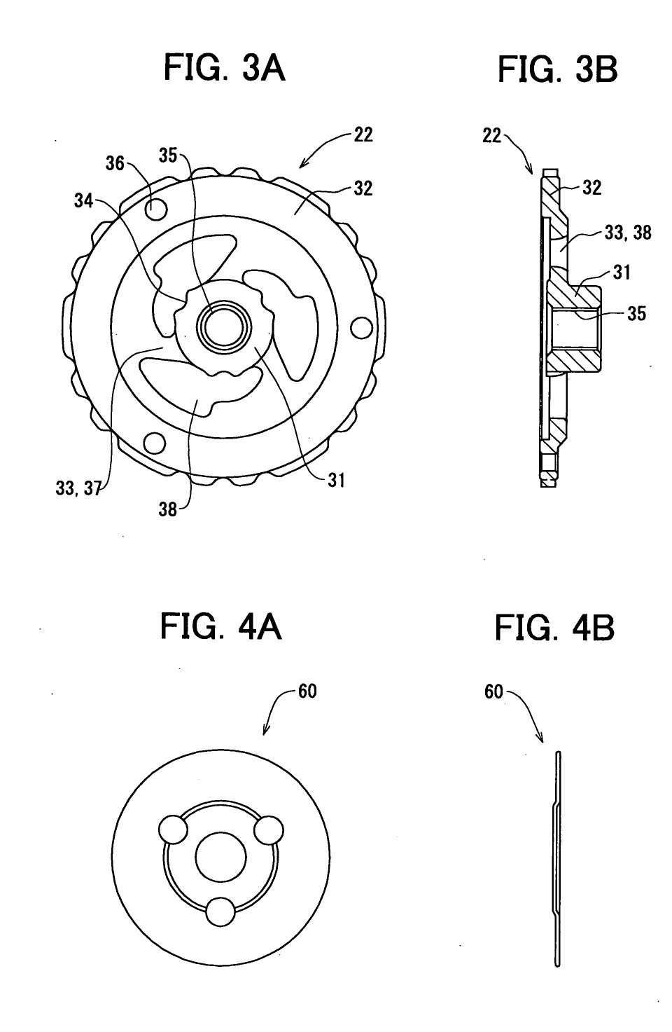

Embodiments of the present invention are now described in detail, with reference to the drawings. FIGS. 1A to 4B show a first embodiment of the present invention. FIGS. 1A and 1B are front and partial side cross-sectional views of a compressor pulley assembly according to the first embodiment of the present invention, respectively. FIG. 2A is a partial front view of an output disk 8 of the compressor pulley assembly shown in FIGS. 1A and 1B, seen from the inner side thereof. FIG. 2B is a partial cross-sectional view of the output disk 8. FIG. 2C is a partial cross-sectional view of a conventional output disk. FIGS. 3A and 3B are front view and cross-sectional views, respectively, of an inner hub 22 of the compressor pulley assembly shown in FIGS. 1A and 1B. FIGS. 4A and 4B are front and cross-sectional views, respectively, of a disk cover 60 of the compressor pulley assembly shown in FIGS. 1A and 1B.

The compressor pulley assembly of the present embodiment is a power transmission device that is arranged in an engine room of a vehicle provided with an engine. The engine corresponds to a drive source of the present invention. The vehicle may be an automobile. The compressor pulley assembly transmits a rotary power of the engine to an auxiliary machine of the engine, which is hereinafter referred to as a compressor. The compressor pulley assembly includes a damping mechanism and a torque limiter mechanism that will be described later.

The compressor, which corresponds to a turning device of the present invention, used in the present embodiment is one component of a refrigeration cycle of a vehicular air conditioner. The compressor is a variable-capacitance refrigerant compressor including a refrigerant compression portion (not shown), discharge amount change means (not shown), and a cylindrical compressor housing (hereinafter, simply referred to as a housing) 1. The discharge amount change means (not shown) can change the discharge amount of refrigerant to 0% of the capacity of the compressor. The cylindrical compressor housing, which is hereinafter simply referred to as a housing 1 accommodates the refrigerant compression portion and the discharge amount change means.

The housing 1 includes a front housing, a cylinder, and a rear housing disposed in that order from a side close to the compressor pulley assembly, for example. The refrigerant compression portion compresses refrigerant taken in and discharges it by rotating the shaft 2. The shaft 2 corresponds to a rotary shaft of the present invention and includes an outer circumferential screw portion (male screw portion) 3 at its top end.

A cylindrical sleeve portion 4 is formed at a front end of the housing 1 integrally with the housing 1 so as to project outward from the center in an axial direction. The sleeve portion 4 is a bearing holder for holding a ball bearing 5 at its outer circumferential portion. A circlip 6 is fitted into the outer circumference of the sleeve portion 4, and locks the ball bearing 5 while sandwiching the ball bearing 5 between the circlip 6 and an annular step portion of the housing 1.

The compressor pulley assembly includes a V pulley 7, an output disk 8, and a plurality of rubber dampers 9. The V pulley 7 always rotates while the engine operates. The output disk 8 is rotated by a torque from the V pulley 7. The plurality of rubber dampers 9 are attached between the V pulley 7 and the output disk 8. The V pulley 7 corresponds to a driving-side rotating body of the present invention, and is formed in a predetermined shape from a metallic material such as an iron-based material or an aluminum-based material, or thermosetting resin such as phenol resin.

The V pulley 7 includes a cylindrical wall portion 11, a sidewall portion 12, a bearing holding portion 13, and the like. The cylindrical wall portion 11 has an approximately cylindrical shape and is always driven by the engine. The sidewall portion 12 is provided on the inner side of the cylindrical wall portion 11 in a radial direction. The bearing holding portion 13 is provided on the inner side of the sidewall portion 12 in the radial direction. The bearing holding portion 13 holds the outer circumference of the ball bearing 5. A multistage V belt (not shown) is wound around the outer circumference of the cylindrical wall portion 11. Thus, a plurality of V-shaped grooves 14 are formed on the outer circumferential surface of the cylindrical wall portion 11 so as to respectively correspond to a plurality of V-shaped grooves formed on the inner circumferential surface of the V belt.

The V belt is also wound around a crank pulley (not shown) attached to a crankshaft of the engine. Moreover, the V belt is wound not only around the compressor pulley assembly but also around V pulley assemblies of other auxiliary machines of the engine including but not limited to an alternator, a water pump of an engine cooling system, and/or a hydraulic pump of a power-steering device.

The sidewall portion 12 has a plurality of axially-extending holes 15, which correspond to concave fitting portions of the present invention formed therein. A plurality of rubber dampers 9 are to be fitted into the plurality of axially-extending holes 15, respectively, as shown in FIG. 1A. The axially-extending holes 15 are arranged at regular intervals, e.g., at intervals of 60°, in the circumferential direction. The output disk 8 corresponds to a driven-side rotating body of the present invention. The output disk 8 is a hub member arranged forward of the sidewall portion 12 of the V pulley 7 so as to be opposed to a front wall face of the sidewall portion 12.

The output disk 8 includes an outer hub 21 and an inner hub 22. The outer hub 21 is arranged in its outer circumferential part (outer part in the radial direction) and is formed of resin. The inner hub 22 is formed of metal. The inner hub 22 is connected to the outer circumference of the shaft 2 of the compressor. The outer hub 21 is integrally molded in a predetermined shape from thermoplastic resin such as nylon, or thermosetting resin such as phenol resin. A plurality of pin portions 23, which correspond to convex fitting portions of the present invention, are provided on a rear wall face of the outer hub 21 at regular intervals, e.g., at intervals of 60°, in the circumferential direction so as to project to the right in FIG. 1B.

The inner hub 22 is integrally formed of metal such as sintered metal, cast iron or aluminum casting, for example, and is molded by insert molding into the outer hub 21. The inner hub 22 includes an approximately cylindrical inner ring portion 31, an outer ring portion 32, and a plurality of bridges 33 (shown in FIGS. 3A and 3B). The approximately cylindrical inner ring portion 31, which is hereinafter simply referred to as an inner ring, is arranged in its inner circumferential part (inner part in the radial direction). The outer ring portion 32, which is hereinafter simply referred to as an outer ring, is in the form of an approximately annular plate that is arranged on the outer circumferential side (outer side in the radial direction) of the inner ring 31. The plurality of bridges 33 includes three in this embodiment and connect the outer circumference of the inner ring 31 to the inner circumference of the outer ring 32.

A tool hole 34 is formed in a central region of the inner ring 31, with which a clamping tool for clamping and fixing the inner hub 22 to the outer circumference of the shaft 2 of the compressor is engaged. In this example, three tool holes 34 are formed. An inner circumferential screw portion 35 is molded at the inner circumference of the inner ring 31. The inner circumferential screw portion 35 is screwed together with the outer circumferential screw portion 3 provided on the outer circumference of the shaft 2 of the compressor.

A surface of the outer ring 32 of the inner hub 22 of the present embodiment is covered with resin forming the outer hub 21. A plurality of (three in this example) circular holes 36 for enhancing a force of connection with the resin forming the outer hub 21 are formed in the outer ring 32. The circular holes 36 are arranged at regular intervals in the circumferential direction. In the embodiment illustrated, the circular holes 36 are located at intervals of 120°. It should be appreciated however that other intervals including regular and irregular intervals may be implemented.

The bridges 33 are provided radially to extend from the outer circumferential surface of the inner ring 31 to the inner circumferential surface of the outer ring 32. The bridges 33 are provided with a plurality of (three in this example) breakable portions 37. In the breakable portions 37, stress that is received by the inner hub 22 of the output disk 8 and is caused by torque transmission is larger than that in other portions. The breakable portions 37 are provided at inner-ring side bases of the bridges 33, respectively, and are arranged between through holes 38 that are formed in the form of an approximate arc extending in the circumferential direction.

The breakable portions 37 form a torque limiter mechanism for blocking a power transmission path from the engine to the shaft 2 of the compressor. More specifically, the breakable portions 37 are preferentially broken so as to separate the outer circumferential part of the inner hub 22 of the output disk 8 from the inner circumferential part thereof when an overload torque (e.g., 40 Nm) that is extremely larger than a normally transmitted torque (e.g., 15 Nm) is generated in the inner hub 22. In this manner, the breakable portions 37 serve as the torque limiter mechanism.

The output disk 8 has a disk cover 60 for covering one end face of the inner hub 22 in the axial direction. The disk cover 60 has a function of protecting the torque limiter mechanism and a function of preventing broken pieces of the breakable portions 37 from being scattered after the torque limiter mechanism operates. The disk cover 60 is formed by insert molding together with the inner hub 22 into the outer hub 21. Please note that the disk cover 60 of the present invention is formed from a nonmetallic material such as gasket, varnished sheet, paper, cloth, or rubber, whereas the disk cover 60 is conventionally formed by an aluminum plate.

The rubber dampers 9 are approximately U-shaped rubber elastic members that are integrally molded from chlorinated butyl rubber, styrene-butadiene rubber, natural rubber, or the like. The rubber dampers 9 have a concave fitting portion 39. The pin portion 23 projecting from the rear wall face of the outer hub 21 backward is fitted into the concave fitting portion 39. Each of the rubber dampers 9 is attached by injection or bonding in a hollow portion between the outer circumferential surface of the pin portion 23 of the outer hub 21 and the inner circumferential surface of the axially-extending hole 15 formed in the front wall face of the sidewall portion 12 of the V pulley 7. The hollow portion has a U-shape from a lateral view. The rubber damper 9 attached in the hollow portion can absorb variation of a torque from the V pulley 7 to the output disk 8.

The description of this embodiment of the present invention now continues with specific reference to FIGS. 2A to 2C. These figures illustrate a structure of the output disk 8 by comparing the structure of the present invention (FIG. 2B) with a conventional structure (FIG. 2C). An outer diameter ΦB of the inner hub 22 is smaller than an inner diameter ΦP of the pin portions 23 in the conventional structure, as shown in FIG. 2C. The outer diameter ΦA of the inner hub 22 is larger than the inner diameter ΦP of the pin portions 23 in the structure of the present invention, as shown in FIG. 2B. In addition, the thickness tB of the outer ring 32 is 2.7 mm in the conventional structure, whereas the thickness tA of the outer ring 32 is 4 mm according to the present invention. Those settings are determined in order to improve the rigidity of the output disk 8. It should be appreciated that while a definitive dimension has been disclosed for the thickness tA of the outer ring 32, the present invention is not limited to that dimension and alternative dimensions operable to effectively serve the principles of the present invention are intended to be included within the scope of the present invention.

Next, an operation of the compressor pulley assembly of the present embodiment is briefly described based on FIGS. 1A and 1B. During normal operation of the compressor pulley assembly, the inner hub 22 of the output disk 8 is held in a state where the inner hub 22 can be driven. Thus, when the engine starts, the crankshaft is rotated and the rotary power (torque) of the engine is transmitted to the cylindrical wall portion 11 of the V pulley 7 through the crank pulley and the V belt.

Then, the torque is transmitted to the rubber damper 9 from the inner circumferential wall face of the axially-extending holes 15 provided in the sidewall portion 12 of the V pulley 7, and is thereafter transmitted from the inner side face of the concave fitting portion 39 of the rubber damper 9 to the outer circumferential surface of the pin portion 23 provided in the outer hub 21 of the output disk 8. Thus, the outer hub 21 is rotated. The inner ring 31, the outer ring 32, and the bridges 33 of the inner hub 22 that is formed into the outer hub 21 by insert molding are also rotated.

Since the inner circumferential screw portion 35 of the inner ring 31 of the inner hub 22 is screwed with the outer circumferential screw portion 3 of the shaft 2 of the compressor, the shaft 2 of the compressor follows the inner hub 22 of the output disk 8 so as to rotate together with the inner hub 22. As a result, the compressor compresses refrigerant taken in by an evaporator (refrigerant evaporator) and discharges high-temperature and high-pressure refrigerant gas to a condenser (refrigerant condenser). In this manner, cooling inside a vehicle such as an automobile can be achieved.

When the shaft 2 of the compressor is locked because of breakdown of the compressor caused by burning thereof or the like, the V pulley 7 tries to continue rotation although the output disk 8 is stopped. Thus, an overload torque (e.g., 40 Nm: impact torque) that is extremely larger than a normally transmitted torque (e.g., 15 Nm) is generated in the inner hub 22 of the output disk 8.

In other words, when a torque difference equal to or larger than a set torque is generated between the inner ring 31 of the inner hub 22 of the output disk 8 and the outer ring 32 thereof, large stress is applied to the breakable portions 37 provided at the inner-ring side bases of the bridges 33 of the inner hub 22, i.e., portions in which stress caused by the torque transmission is larger than that in other portions. Thus, the breakable portions 37 are preferentially broken.

Therefore, the inner ring 31 and the outer ring 32 of the inner hub 22 are separated from each other, so that the V pulley 7, the rubber dampers 9, the outer hub 21 of the outer disk 8, and the outer ring 32 of the inner hub 22 can freely rotate on their axes, respectively, with respect to the inner ring 31 of the inner hub 22. In this manner, when the torque difference equal to or larger than the set torque is generated between the inner ring 31 and the outer ring 32 of the inner hub 22, the breakable portions 37 respectively provided in the bridges 33 are preferentially broken.

That is, when the torque limiter mechanism operates, the transmission of the torque from the V pulley 7 to the shaft 2 of the compressor is blocked. Thus, the power transmission path from the engine to the shaft 2 of the compressor is blocked. When the inner hub 22 is broken at the breakable portions 37, the outer hub 21 of the output disk 8, and the outer ring 32 and the outer circumferential part of the bridge 33 of the inner hub 22 are separated from the inner ring 31 and the inner circumferential part of the bridge 33 of the inner hub 22. In order to reduce their diameters toward the compressor with respect to an axial line parallel to the axial direction of the shaft 2 of the compressor, the plurality of breakable portions 37 are provided to be inclined.

Therefore, the outer hub 21 of the outer disk 8, and the outer ring 32 and the outer circumferential part of the bridge 33 of the inner hub 22 do not move forward (left in FIG. 1B) of the front end face of the cylindrical wall portion 11 of the V pulley 7, and are held on the inner circumferential side of the cylindrical wall portion 11 of the V pulley 7. Thus, the outer hub 21 of the output disk 8, and the outer ring 32 and the outer circumferential part of the bridge 33 of the inner hub 22 are rotated together with the rubber dumpers 9 with the rotation of the V pulley 7.

Next, features of the present embodiment and effects achieved by those features are described. First, the output disk 8 includes the annular outer hub 21 made of resin and the annular inner hub 22 made of metal. The outer hub 21 is arranged in the outer circumferential part of the output disk 8 and has the pin portions 23. The inner hub 22 is arranged in the inner circumferential part of the output disk 8, is formed into the outer hub 21 by insert molding, and is connected to the outer circumference of the shaft 2. The outer diameter ΦA of the inner hub 22 is set to be larger than the inner diameter ΦP of the pin portions 23.

The inner hub 22 includes the inner ring 31 that is approximately cylindrical and is connected to the outer circumference of the shaft 2, and the outer ring 32 in the form of an approximately annular plate that is arranged on the outer circumferential side of the inner ring 31. The thickness tA of the outer ring 32 is set to 4 mm. The output disk 8 further includes the disk cover 60 for covering one end face of the inner hub 22 in the axial direction. The disk cover 60 is formed from a nonmetallic material.

The present invention provides a structure that increases the rigidity of the output disk 8 as a source of sound so as to suppress vibration of the output disk 8 (i.e., generation of sound in the output disk 8). More specifically, in the present embodiment, the rigidity of the output disk 8 is increased by making the outer diameter ΦA of the inner hub 22 formed of metal larger until the inner hub 22 reaches the pin portions 23 formed of resin and by making the thickness tA of the outer ring 32 of the inner hub 22 formed of metal thicker.

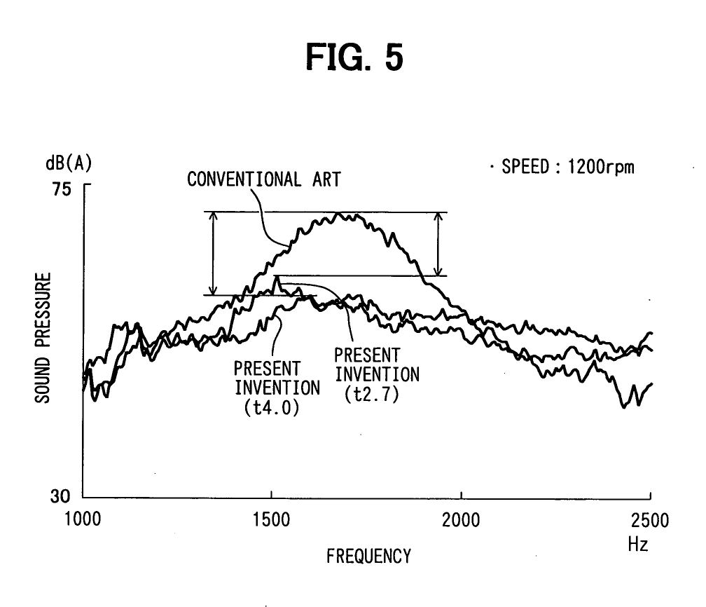

In this structure, the vibration of the output disk 8 can be suppressed, and the noises around the frequency of 1.5 to 2 kHz that are generated in the conventional technique while the compressor as the turning device is turned off can be reduced. FIG. 5 is a graph showing a relationship between the frequency of sound generated by the compressor and a sound pressure. The effect of the present embodiment is apparent from FIG. 5. As compared with the conventional output disk, the output disk of the present invention in which the inner hub is larger and the outer ring of the inner hub has the same thickness (shown as a product of the present invention (2.7 mm)) and the output disk of the present invention in which the inner hub is larger and the outer ring of the inner hub is thicker (shown as a product of the present invention (4 mm)) have effects of reducing the sound, as shown in FIG. 5.

Moreover, this structure can reduce the noises only by modifying the output disk 8 without increasing the size of the output disk 8 or modifying other components of the power transmission device. In addition, inertia weight of the inner hub 22 is increased. Thus, a torque (rotation) variation caused by compression work of the compressor can be reduced.

Furthermore, the present embodiment provides a structure that can suppress generation of sound from the disk cover 60 by changing the natural frequency of the disk cover 60 serving as one source of sound. In this structure, the disk cover 60 is formed from a nonmetallic material such as gasket, varnished sheet, paper, cloth, or rubber, whereas the disk cover 60 in the conventional technique is formed by an aluminum plate.

The use of a material having a natural frequency different from aluminum changes a resonance point. Thus, the noises around the frequency of 1.5 to 2 kHz that are generated in the conventional technique while the compressor as the turning device is turned off can be reduced. Moreover, the noises can be reduced only by modifying the disk cover 60 without modifying other components of the power transmission device.

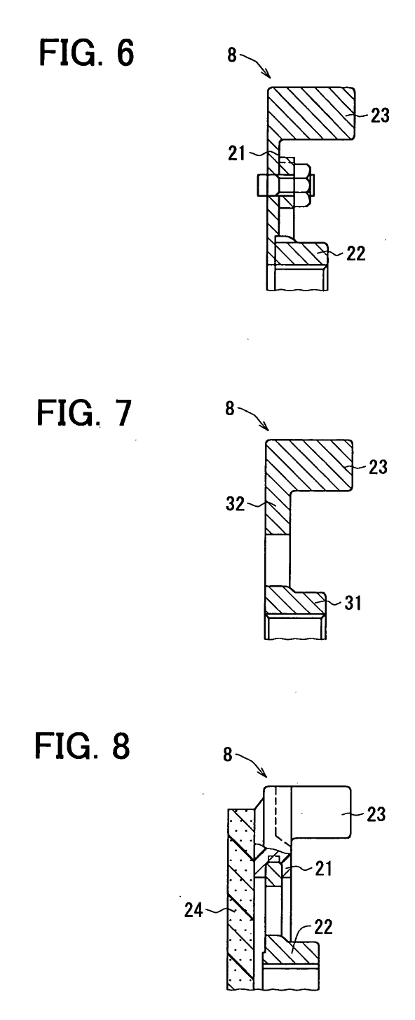

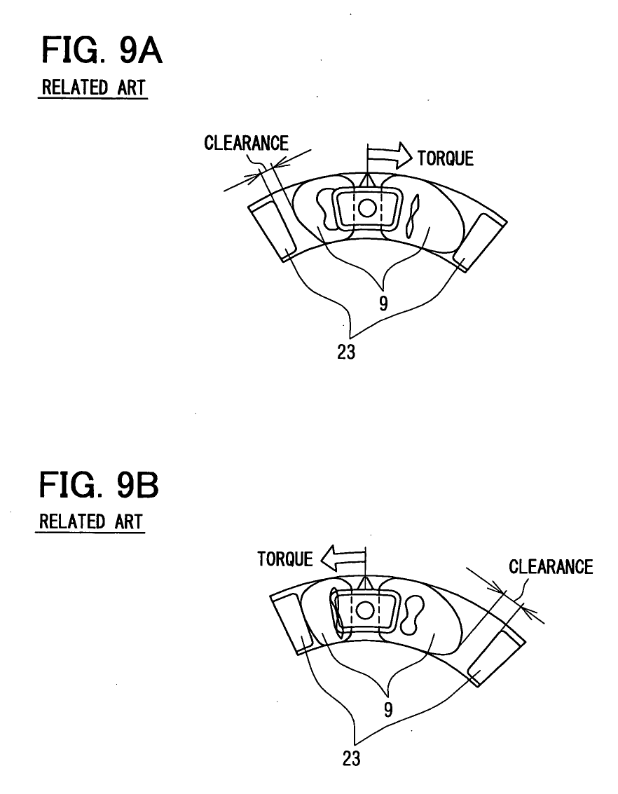

FIG. 6 is a partial cross-sectional view of an output disk 8 according to a second embodiment of the present invention. The output disk 8 includes an annular outer hub 21 formed of metal and an annular inner hub 22 formed of metal. The outer hub 21 is arranged in an outer circumferential part of the output disk 8 and has pin portions 23. The inner hub 22 is arranged in an inner circumferential part of the output disk 8 and is connected to the outer hub 21. The inner hub 22 is connected to the outer circumference of the shaft 2. The second embodiment is different from the first embodiment described above in that the outer hub 21 is also formed of metal and is connected to the inner hub 22 formed of metal by thread fastening, for example.

The present embodiment also provides a structure that increases the rigidity of the output disk 8 serving as a source of sound so as to suppress the vibration of the output disk 8 (i.e., generation of sound in the output disk 8). More specifically, in the present embodiment, the rigidity of the output disk 8 is increased by forming the outer hub 21 of metal unlike the outer hub 21 in the conventional structure formed of resin.

In this structure, the vibration of the output disk 8 can be suppressed, and the noises around the frequency band of 1.5 to 2 kHz that are generated in the conventional technique while the compressor as the turning device is turned off can be reduced. Moreover, this structure can reduce the noises only by modifying the output disk 8 without increasing the size of the output disk 8 or modifying other components of the power transmission device. In addition, the torque (rotation) variation caused by compression work of the refrigerant compressor can be reduced by increase of the inertia weight of the output disk 8. Furthermore, the outer hub 21 covers one end face of the inner hub 22 in the axial direction. Thus, the need of the disk cover 60 can be eliminated and the cost of the power transmission device can be suppressed.

FIG. 7 is a partial cross-sectional view of an output disk 8 according to the third embodiment of the present invention. The output disk 8 includes an approximately cylindrical inner ring 31 that is connected to the outer circumference of the shaft 2, and an outer ring 32 in the form of an approximately annular plate that is arranged on the outer circumferential side of the inner ring 31 and includes pin portions 23. The inner ring 31 and the outer ring 32 are formed of metal integrally with each other. The present embodiment is different from the aforementioned embodiments only in that the output disk 8 is integrally formed of metal.

The present embodiment also provides a structure that increases the rigidity of the output disk 8 serving as a source of sound so as to suppress the vibration of the output disk 8 (i.e., generation of sound in the output disk 8). More specifically, in the present embodiment, the rigidity of the output disk 8 is increased by integrally forming the output disk 8 that conventionally includes the outer hub 21 and the inner hub 22, from a metallic material.

In this structure, the vibration of the output disk 8 can be suppressed, and the noises around the frequency band of 1.5 to 2 kHz that are generated in the conventional technique while the compressor as the turning device is turned off can be reduced. Moreover, the reduction of noises can be achieved only by modifying the output disk 8 without increasing the size of the output disk 8 or modifying other components of the power transmission device. Furthermore, the torque (rotation) variation caused by compression work of the refrigerant compressor can be reduced by increase of inertia weight of the output disk 8.

FIG. 8 is a partial cross-sectional view of an output disk 8 according to the fourth embodiment of the present invention. The output disk 8 includes an annular outer hub 21, an annular inner hub 22, and a sound absorbing member 24. The annular outer hub 21 is made of resin that is arranged in an outer circumferential part of the output disk 8 and includes pin portions 23. The annular inner hub 22 is made of metal that is arranged in an inner circumferential part of the output disk 8 and is formed into the outer hub 21 by insert molding. The sound absorbing member 24 covers end faces of the outer hub 21 and the inner hub 22 in the axial direction. The inner hub 22 is connected to the outer circumference of the shaft 2.

The present embodiment provides a structure that covers the output disk 8 serving as a source of sound with the sound absorbing member 24 so as to suppress propagation of sound from the output disk 8. More specifically, in the present embodiment, one end face of the output disk 8 is covered with the sound absorbing member 24 formed of rubber, styrene-foam, sponge, cork, or the like. Thus, the propagation of sound from the output disk 8 can be suppressed, so that the noises around the frequency band of 1.5 to 2 kHz that are generated in the conventional structure while the compressor as a turning device is turned off can be reduced.

Moreover, this structure can reduce the noises only by adding the sound absorbing member 24 without increasing the size of the output disk 8 or modifying other components of the power transmission device. In addition, the sound absorbing member 24 has a function of protecting the torque limiter mechanism and a function of preventing scattering of broken pieces after the torque limiter mechanism operates, which are functions of the disk cover 60. Thus, the need of the disk cover 60 can be eliminated and the cost of the power transmission device can be suppressed.

In the aforementioned embodiments, an example in which the present invention is applied to the compressor pulley assembly that is driven by the drive source such as an engine mounted on a vehicle such as an automobile through a belt is described. However, the present invention is not limited to the aforementioned embodiments. The present invention may be applied to a power transmission device that is driven through a belt by a drive source such as an internal-combustion engine or an electric motor placed in a certain position in the vehicle or a factory, or is directly driven by an output shaft.

The multistage V pulley (i.e., so-called V-ribbed pulley) is used as the driving-side rotating body in the aforementioned embodiments. Alternatively, a V pulley having a single V-shaped groove may be used as the driving-side rotating body. In this case, a V belt having an inner circumferential shape corresponding to an outer circumferential shape of that V pulley.

In the aforementioned embodiments, an example is described in which the present invention is applied to the compressor pulley assembly (power transmission device) that is provided with the torque limiter mechanism and always drives the shaft 2 of the compressor forming one component of the refrigeration cycle of the vehicular air conditioner. However, the present invention may be applied to a power transmission device that is provided with a limiter mechanism and always drives another turning device (an alternator, a water pump, a hydraulic pump, a blower, or a fan, for example).

1. A power transmission device comprising:
a driving-side rotating body rotated by a rotary power from a drive source, the driving-side rotating body having a concave fitting portion provided on an end face thereof in an axial direction; and
a driven-side rotating body connected to a rotary shaft of a turning device, the driven-side rotating body having a convex fitting portion provided on an end face in the axial direction, the convex fitting portion being fitted into the concave fitting portion to be connected thereto to transmit rotation of the driving-side rotating body to the driven-side rotating body, wherein
the driven-side rotating body includes an annular outer hub formed of a resin and an annular inner hub formed of a metal, the outer hub being arranged in an outer circumferential part of the driven-side rotating body and having the convex fitting portion, the inner hub being arranged in an inner circumferential part of the driven-side rotating body, the inner hub being formed into the outer hub by insert molding, the inner hub being connected to an outer circumference of the rotary shaft; and
an outer diameter of the inner hub is set to be larger than an inner diameter of the convex fitting portion.

2. A power transmission device comprising:
a driving-side rotating body rotated by a rotary power from a drive source, the driving-side rotating body having a concave fitting portion provided on an end face thereof in an axial direction; and
a driven-side rotating body connected to a rotary shaft of a turning device, the driven-side rotating body having a convex fitting portion provided on an end face thereof in the axial direction, the convex fitting portion being fitted into the concave fitting portion to be connected thereto to transmit rotation of the driving-side rotating body to the driven-side rotating body, wherein
the driven-side rotating body includes an annular outer hub made of a resin and an annular inner hub made of a metal, the outer hub being arranged in an outer circumferential part of the driven-side rotating body and having the convex fitting portion, the inner hub being arranged in an inner circumferential part of the driven-side rotating body, the inner hub being formed into the outer hub by insert molding;
the inner hub includes an approximately cylindrical inner ring portion connected to an outer circumference of the rotary shaft, and an outer ring portion in the form of an approximately annular plate that is arranged on an outer circumferential side of the inner ring portion; and
the outer ring portion has a thickness of 3 mm or more.

3. The power transmission device according to claim 2, wherein the outer ring portion has a thickness of 4 mm or more.

4. The power transmission device according to claim 1, wherein
the driven-side rotating body includes a disk cover for covering an end face of the inner hub in the axial direction, and
the disk cover is formed of a nonmetallic material.

5. The power transmission device according to claim 2, wherein
the driven-side rotating body includes a disk cover for covering an end face of the inner hub in the axial direction, and
the disk cover is formed of a nonmetallic material.

6. A power transmission device comprising:
a driving-side rotating body rotated by a rotary power from a drive source, the driving-side rotating body having a concave fitting portion on an end face thereof in an axial direction; and
a driven-side rotating body connected to a rotary shaft of a turning device, the driven-side rotating body having a convex fitting portion provided on an end face thereof in the axial direction, the convex fitting portion being fitted into the concave fitting portion to be connected thereto to transmit rotation of the driving-side rotating body to the driven-side rotating body, wherein
the driven-side rotating body includes an annular outer hub made of a metal and an annular inner hub made of a metal, the outer hub being arranged in an outer circumferential part of the driven-side rotating body and having the convex fitting portion, the inner hub being arranged in an inner circumferential part of the driven-side rotating body and being connected to the outer hub and an outer circumference of the rotary shaft.

7. The power transmission device according to claim 6, wherein
the outer hub covers an end face of the inner hub in the axial direction.

8. A power transmission device comprising:
a driving-side rotating body rotated by a rotary power from a drive source, the driving-side rotating body having a concave fitting portion provided on an end face thereof in an axial direction; and
a driven-side rotating body connected to a rotary shaft of a turning device, the driven-side rotating body having a convex fitting portion provided on an end face thereof in the axial direction, the convex fitting portion being fitted into the concave fitting portion to be connected thereto to transmit rotation of the driving-side rotating body to the driven-side rotating body, wherein
the driven-side rotating body includes an approximately cylindrical inner ring portion connected to an outer circumference of the rotary shaft, and an outer ring portion in the form of an approximately annular plate that is arranged on an outer circumferential side of the inner ring portion and has the convex fitting portion, the inner ring portion and the outer ring portion being integrally formed of a metal.

9. A power transmission device comprising:
a driving-side rotating body rotated by a rotary power from a drive source, the driving-side rotating body having a concave fitting portion provided on an end face thereof in an axial direction; and
a driven-side rotating body connected to a rotary shaft of a turning device, the driven-side rotating body having a convex fitting portion provided on an end face thereof in the axial direction, the convex fitting portion being fitted into the concave fitting portion to be connected thereto to transmit rotation of the driving-side rotating body to the driven-side rotating body, wherein
the driven-side rotating body includes an annular outer hub made of a resin, an annular inner hub made of a metal, and a sound absorbing member for covering end faces of the outer hub and the inner hub in the axial direction, the outer hub being arranged in an outer circumferential part of the driven-side rotating body and having the convex fitting portion, the inner hub being arranged in an inner circumferential part of the driven-side rotating body, the inner hub being formed into the outer hub by insert molding, the inner hub being connected to an outer circumference of the rotary shaft.

10. The power transmission device of claim 1, wherein the power transmission device is utilized in a variable-capacitance compressor for a vehicular air conditioner.

11. The power transmission device of claim 2, wherein the power transmission device is utilized in a variable-capacitance compressor for a vehicular air conditioner.

12. The power transmission device of claim 6, wherein the power transmission device is utilized in a variable-capacitance compressor for a vehicular air conditioner.

13. The power transmission device of claim 8, wherein the power transmission device is utilized in a variable-capacitance compressor for a vehicular air conditioner.

14. The power transmission device of claim 9, wherein the power transmission device is utilized in a variable-capacitance compressor for a vehicular air conditioner.
